(19) United States
(12) Patent Application Publication
(10) Pub. No.: US 2014/0330654 A1
(43) Pub. Date: Nov. 6, 2014

(54) PAYMENT OF RESTAURANT BILLS

(71) Applicants: Christopher Michael Turney, Aliso Viejo, CA (US); Eric Richard Tarczynski, Vernon, NJ (US); Daniel Moreh, Woodland Hills, CA (US); Richard Andrew Fickling, Glenwood City, WI (US)

(72) Inventors: Christopher Michael Turney, Aliso Viejo, CA (US); Eric Richard Tarczynski, Vernon, NJ (US); Daniel Moreh, Woodland Hills, CA (US); Richard Andrew Fickling, Glenwood City, WI (US)

(21) Appl. No.: 13/875,757

(22) Filed: May 2, 2013

(51) Int. Cl. G06Q 20/14; G06Q 20/32

(52) U.S. Cl. CPC G06Q 20/14; G06Q 20/3224
USPC 705/15

(57) ABSTRACT

A method includes identifying a restaurant where a user of a mobile device is located; receiving, from the restaurant, data indicative of one or more items on a bill associated with the user; providing the data to the mobile device; and enabling the user to pay for one or more of the items on the bill using the mobile device.

### BACKGROUND

When dining at a restaurant, customers generally pay their bill with cash, a credit card, or a debit card at the restaurant. At some restaurants, customers dining in a group can ask their server to prepare a separate check for each customer in the group. At other restaurants, customers dining in a group each contribute their estimated portion of a single overall bill.

### SUMMARY

In general, in an aspect, a method includes identifying a restaurant where a user of a mobile device is located; receiving, from the restaurant, data indicative of one or more items on a bill associated with the user; providing the data to the mobile device; and enabling the user to pay for one or more of the items on the bill using the mobile device.

Implementations may include one or more of the following features.

Identifying the restaurant includes determining a location of the mobile device. Determining the location of the mobile device includes determining the location based on location data received by the mobile device.

Identifying the restaurant includes identifying the restaurant based on data from the mobile device representative of input from the user.

The method includes sending a request for the data to the restaurant.

The method includes identifying a ticket associated with the user. Identifying a ticket associated with the user includes receiving data from the mobile device identifying a table of the user. The method includes sending a request for the data to the restaurant, the request including an identifier of the ticket.

Receiving the data includes receiving one or more of a name, a price, and a quantity associated with each of one or more of the items on the bill.

The items on the bill include items ordered by a person other than the user. The method includes providing the data to a second mobile device associated with the person other than the user; and enabling the person other than the user to pay for one or more of the items using the second mobile device. The method includes enabling the person other than the user to pay for one or more items using the mobile device. The method includes enabling the user and the person other than the user to each pay for a respective fraction of the cost of the same item. The data received from the restaurant includes payment data indicative of a payment by the person other than the user. The payment data is indicative of a payment made by the person other than the user without using a mobile device. The mobile device comprises a first mobile device, and comprising, receiving from a second mobile device, data indicative of a selection of items, a payment, or both, by the person other than the user.

Enabling the user to pay for one or more of the items includes receiving data from the mobile device identifying the one or more items; and enabling the user to pay for the identified items.

Enabling the user to pay for one or more of the items comprises sending data about the one or more items to a payment processor.

The method includes providing a confirmation of payment to the mobile device. The confirmation includes a status of the bill. The confirmation includes an amount still owed on the bill.

The method includes identifying a reward available to the user. The reward is a discount. Identifying the reward includes identifying the reward based on the restaurant, the items on the bill, or both. Identifying the promotion includes identifying the most relevant reward based on a history of actions of the user. The history of actions of the user includes a history of actions of the user related to dining. The history of actions of the user related to dining includes a history of restaurants visited by the user, a history of items on bills associated with the user, or both.

In general, in an aspect, a computer readable medium stores instructions for causing a computer system to identify a restaurant where a user of a mobile device is located; receive, from the restaurant, data indicative of items on a bill associated with the user; provide the data to the mobile device; and enable the user to pay for one or more of the items on the bill using the mobile device.

In general, in an aspect, a method includes receiving input from a user at a mobile device identifying a restaurant where the user is located; receiving data at the mobile device indicative of items on a bill from the restaurant, the bill associated with the user; displaying a representation of the items on the bill on a user interface of the mobile device; and receiving input from the user selecting one or more of the items for payment.

Implementations may include one or more of the following features.

Receiving input from the user identifying the restaurant includes receiving a selection of the restaurant from a plurality of restaurants.

The method includes receiving input from the user indicative of a ticket associated with the user. Receiving input indicative of a ticket includes receiving an identification of a table of the user.

The method includes enabling selection of one or more of the items. Enabling the selection comprises enabling the user to select a first item and enabling a person other than the user to select a second item. The first item and the second item comprise the same item. The user and the person other than the user each pay for a respective fraction of the cost of the same item.

The method includes providing data identifying the selected one or more items to a computing server. The method includes receiving a confirmation of payment. The method includes displaying a representation of the confirmation on the user interface of the mobile device.

The method includes enabling the user to specify a tip amount.

The method includes displaying discounts available to the user on the user interface of the mobile device.

In general, in an aspect, a computer readable storage medium stores instructions for causing a computing system to receive input from a user at a mobile device identifying a restaurant where the user is located; receive data at the mobile device indicative of items on a bill from the restaurant, the bill associated with the user; display a representation of the items on the bill on a user interface of the mobile device; and receive input from the user selecting one or more of the items for payment.

In general, in an aspect, a method includes identifying a restaurant where a user of a mobile device is located; receiving, from the restaurant, data indicative of items on a bill associated with the user; providing the data to the mobile device; enabling the user to pay for a first item on the bill using the mobile device; and enabling a person other than the user to pay for a second item on the bill.

Implementations may include one or more of the following features.

Enabling the user to pay for the first item comprises receiving data from the mobile device associating the first item with the user.

Enabling the person other than the user to pay for the second item comprises receiving data from the mobile device associating the second item with the person.

The first item and the second item are the same item. Enabling the user to pay for the first item comprises enabling the user to pay for a first fraction of a cost of the same item, and in which enabling the person other than the user to pay for the second item comprises enabling the person other than the user to pay for a second fraction of the same item.

The mobile device is a first mobile device, and comprising providing the data to a second mobile device associated with the person other than the user. Enabling the person other than the user to pay for the second item includes enabling the person other than the user to pay for the second item using the second mobile device.

In general, in an aspect, a method includes maintaining stored data about one or more users of a hosted system that enables customers of restaurants to interact on mobile devices with information that is received at the hosted system from point of sale systems operated by the restaurants and is sent to the mobile devices from the hosted system, the stored data including information about use of the system by the one or more users, and data about restaurants visited by the one or more users, data about items ordered by the one or more users, or both; analyzing the stored data to identify commercially relevant patterns or trends; and providing a result based on the analysis to one or more of the users, one or more of the restaurants, or both.

Implementations may include one or more of the following features.

Providing a result based on the analysis includes providing a reward to one or more of the users.

Providing a result based on the analysis to one or more of the restaurants includes providing a summary of the at least some of the identified patterns or trends to one or more of the restaurants.

The patterns or trends are indicative of a behavior of a subset of the one or more users. The patterns or trends are indicative of a behavior of a particular demographic group. The patterns or trends are indicative of a behavior of a particular user of the one or more users.

The data includes demographic data about the one or more users.

In general, in an aspect, a method includes providing from a central server to mobile devices of diners located in restaurants that are controlled independently of one another and independently of the central server, real time information about tickets associated with the diners by point of sale systems in the respective restaurants.

In general, in an aspect, a method includes from a central server, enabling each of two or more diners at a table in a restaurant to use his respective mobile device to indicate one or more specific menu items or portions of one or more specific menu items that (a) are known to be on a ticket for the table maintained by a point of sale system of the restaurant, and (b) are to be paid for by that diner.

Advantages may include one or more of the following.

Restaurant customers can save time when paying their restaurant bill because they do not have to wait for their server to deliver the bill, collect payment, and return the receipt. Customers can also save money by receiving personalized rewards based on their dining habits and the dining habits of similar customers, their location, their social profile, and their responses to survey questions. Splitting a check among a group of diners is easy, efficient, and fair. In addition, because customers' credit information is handled by a secure payment processing server rather than by a person at the restaurant, customers' financial information can be safeguarded.

Restaurants that adopt the mobile payment system described here can see faster table turns as customers pay using their mobile devices rather than waiting for the restaurant server to process their bill. In-depth analytics about customer behavior can be provided to restaurants for business analysis. For instance, restaurants can use information about their customers to provide individualized, time-sensitive rewards that can help drive higher customer retention. Pattern-based recommendations and rewards can be developed to help increase up-selling to new and existing customers. In addition, restaurants can learn the patterns and preferences of their customers, enabling restaurants to improve their customer service and menu offerings to match the needs and desires of their customers. In addition, the mobile payment system described here can be implemented with little effort by the restaurant and can be compatible with restaurants' existing accounting procedures and compliant with various security standards.

These and other aspects, features, and implementations, and combinations of them, can be expressed as methods, apparatus, systems, components, software products, business methods, means and steps for performing functions, and in other ways.

Other features and advantages will be apparent from the following description and from the claims.

### DESCRIPTION

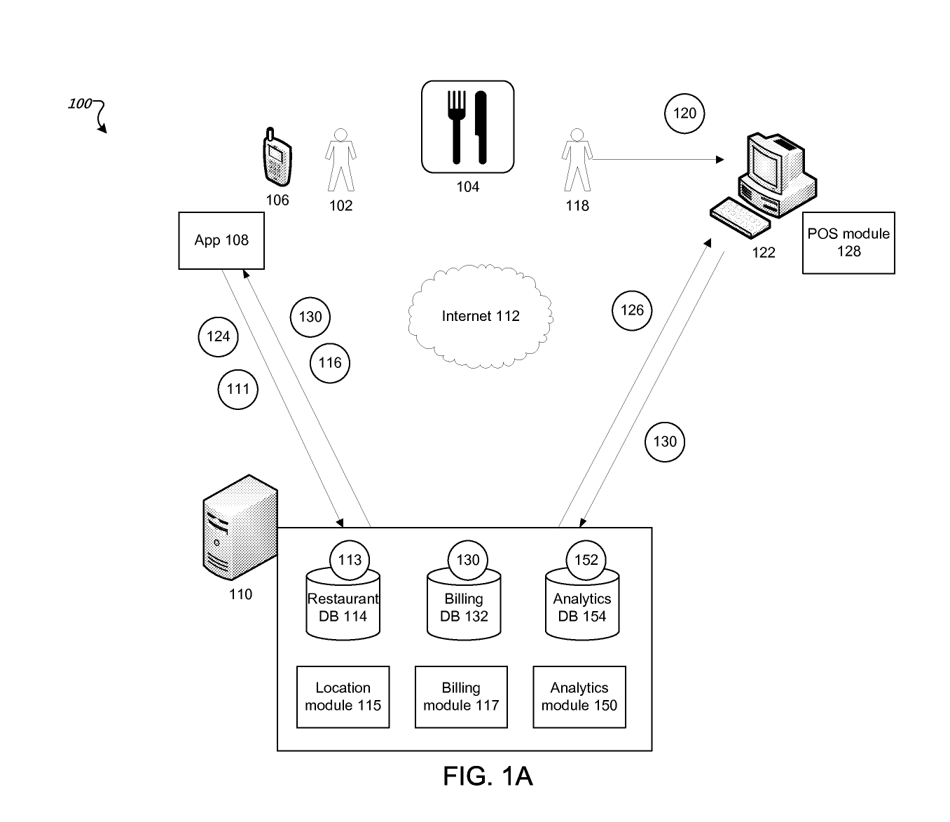

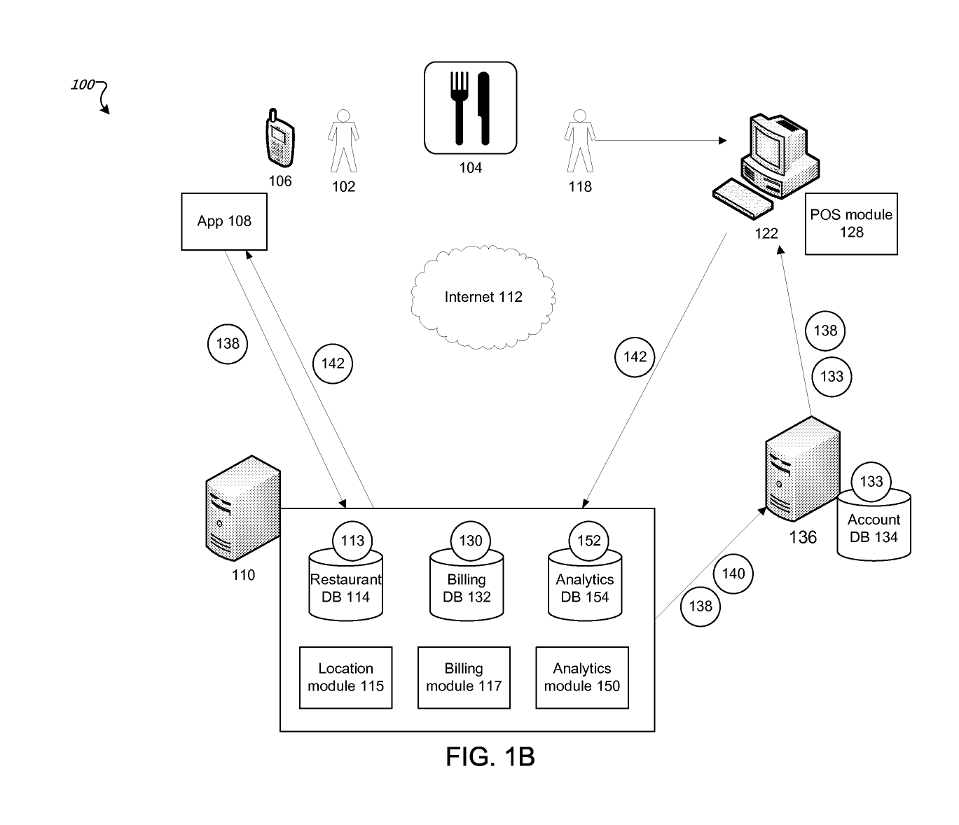

FIGS. 1A and 1B are system diagrams.

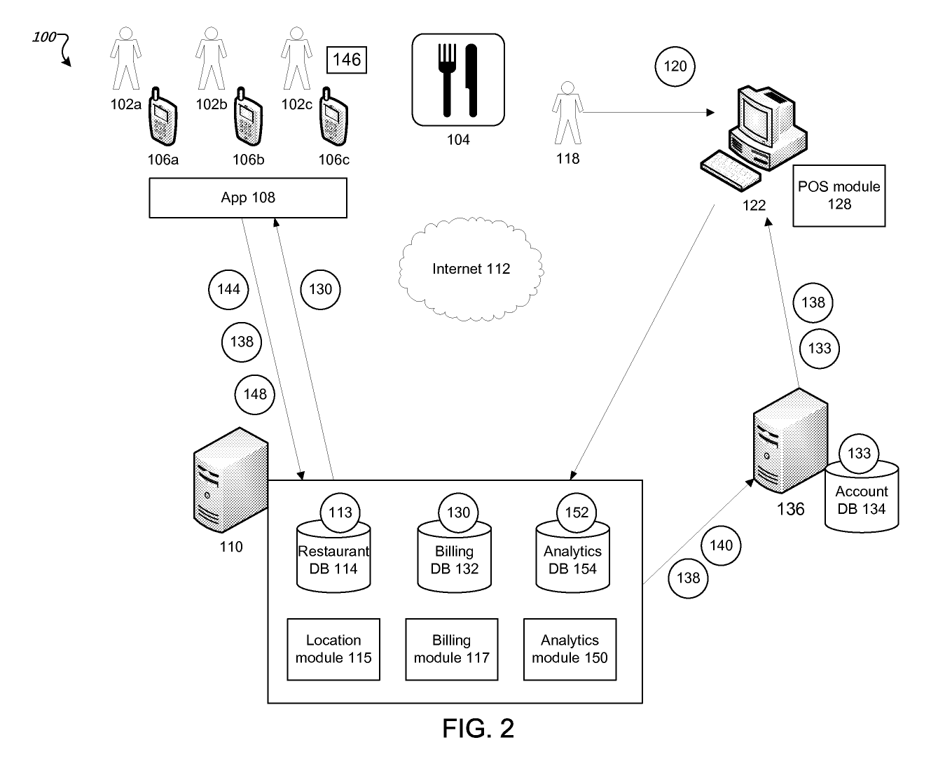

FIG. 2 is a system diagram.

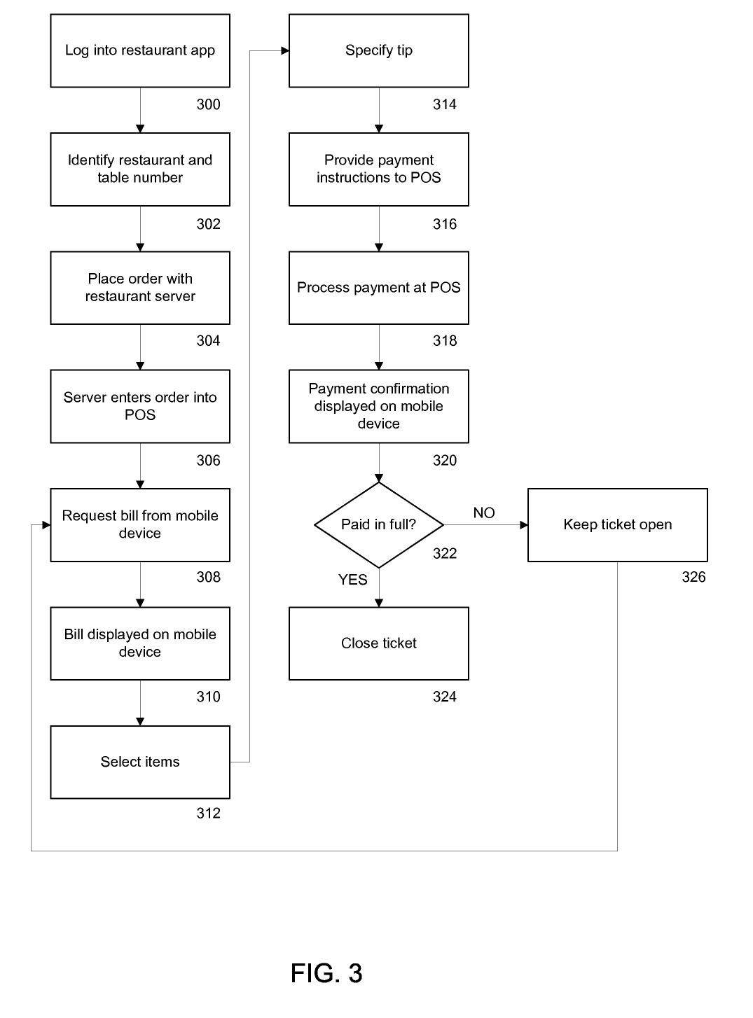

FIG. 3 is a flow chart.

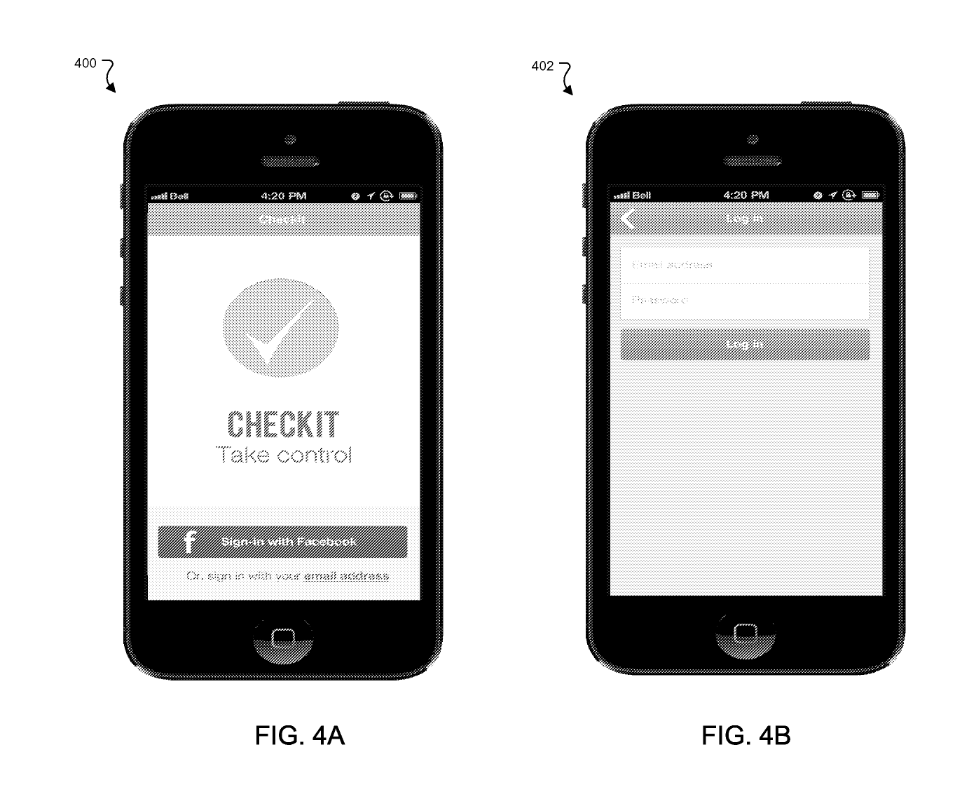

FIGS. 4A and 4B are screenshots.

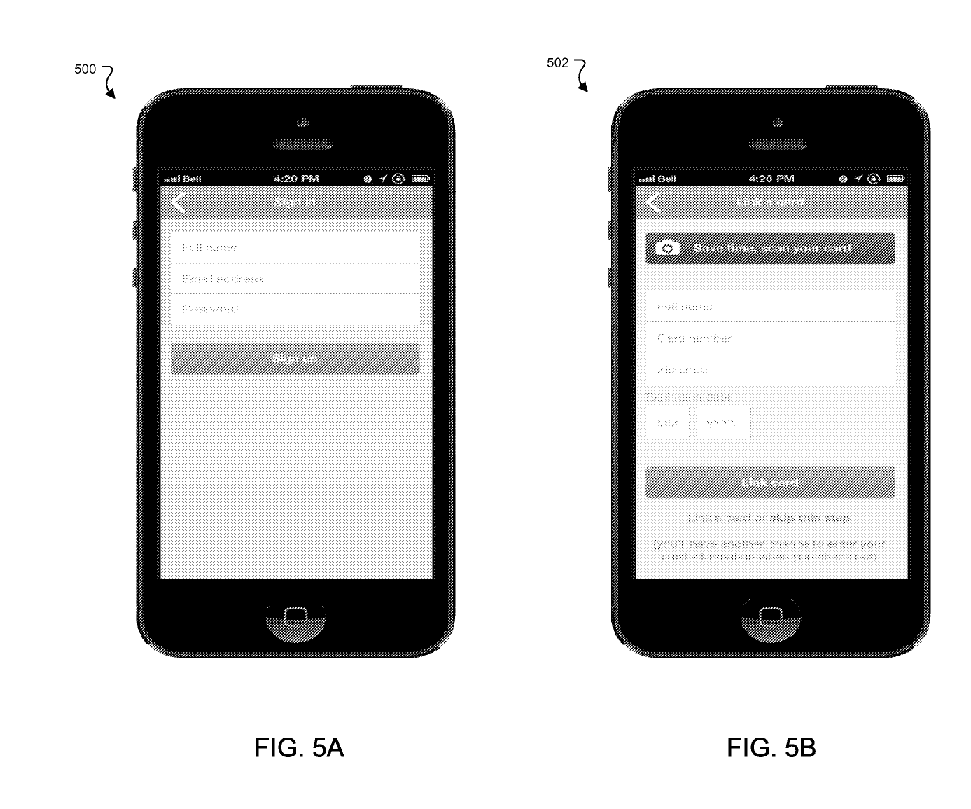

FIGS. 5A and 5B are screenshots.

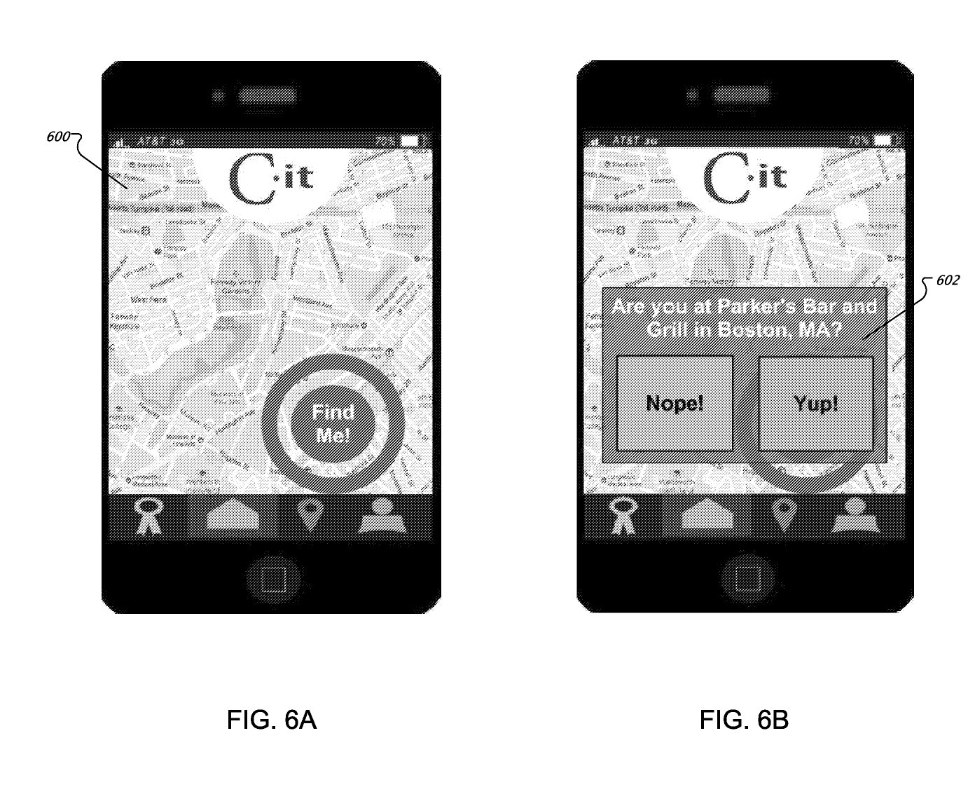

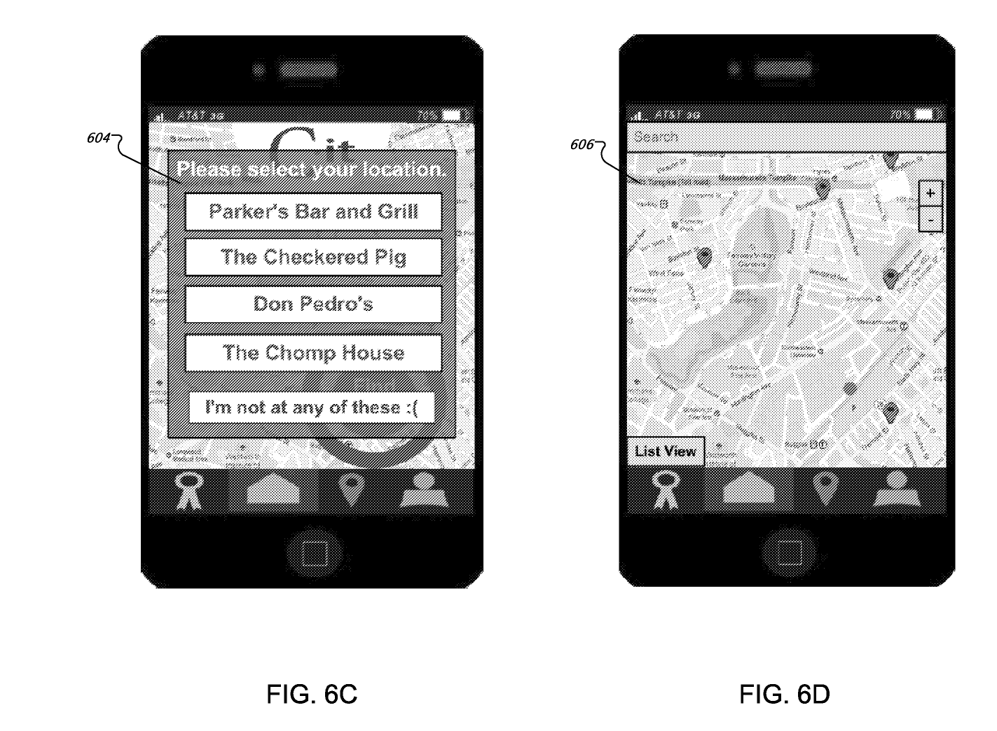

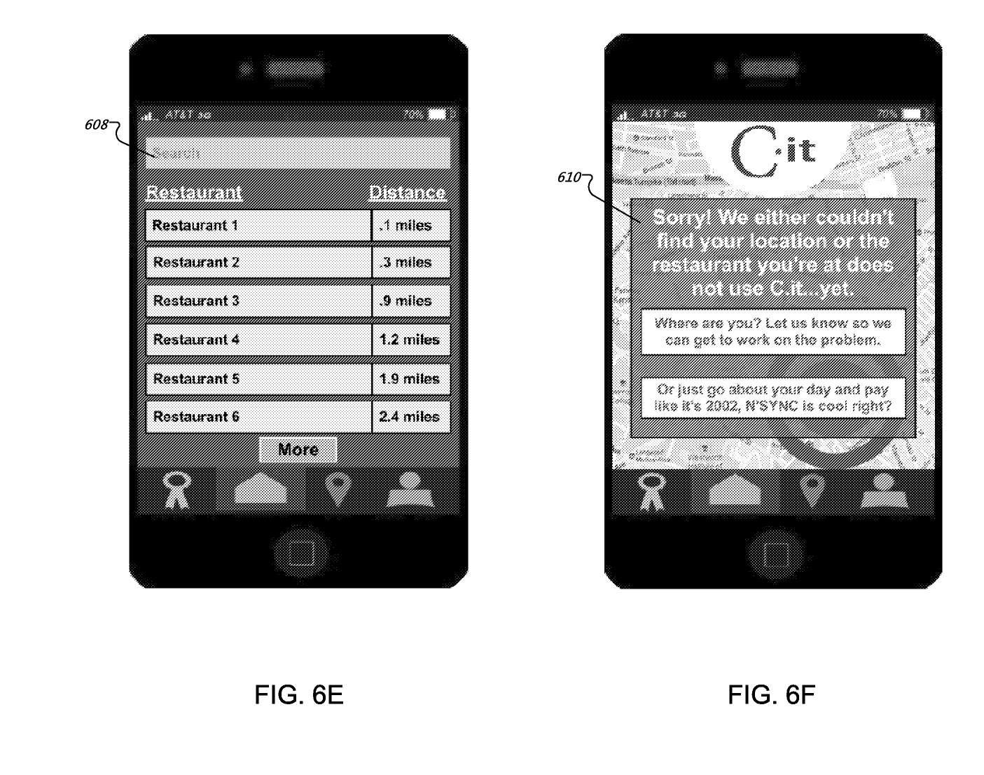

FIGS. 6A-6F are screenshots.

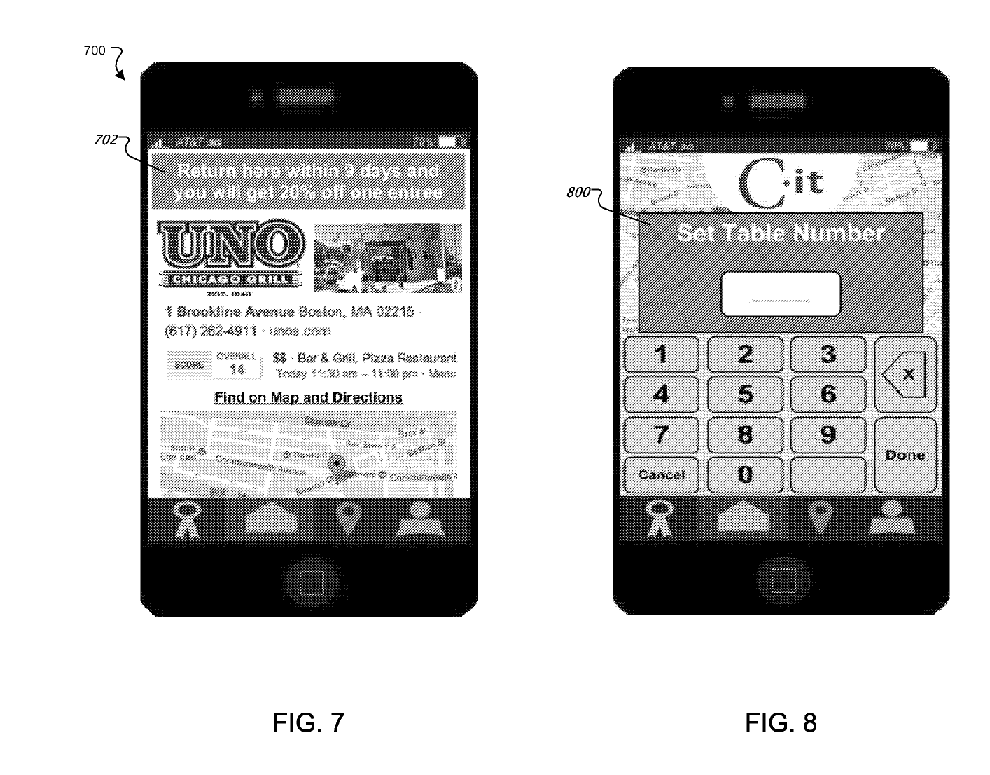

FIGS. 7-10 are screenshots.

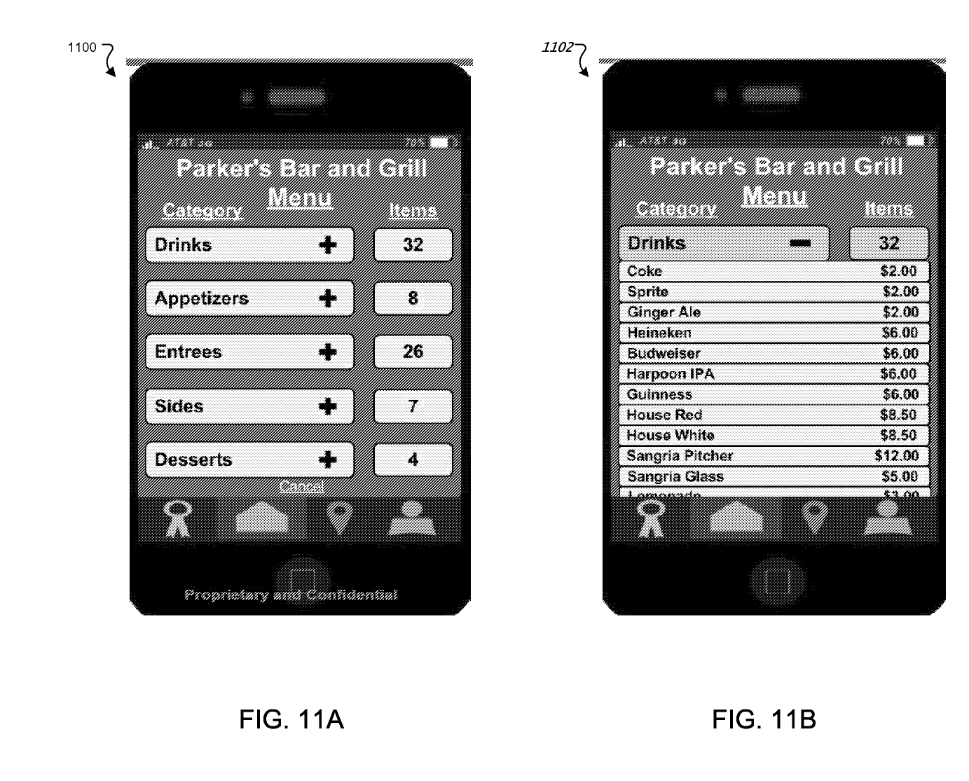

FIGS. 11A and 11B are screenshots.

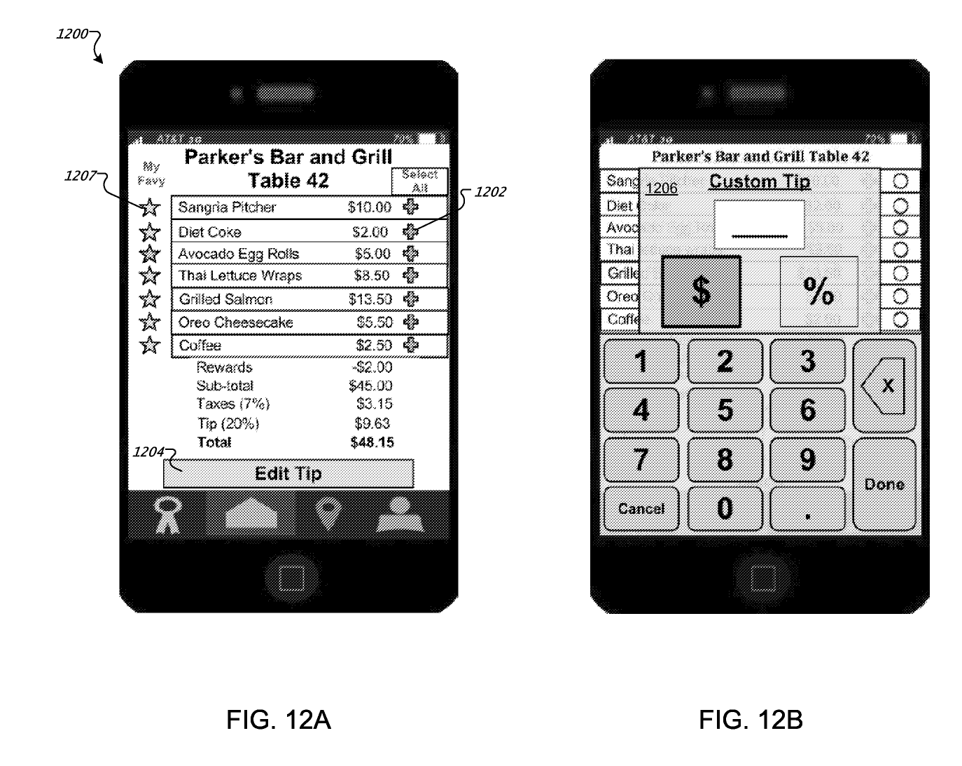

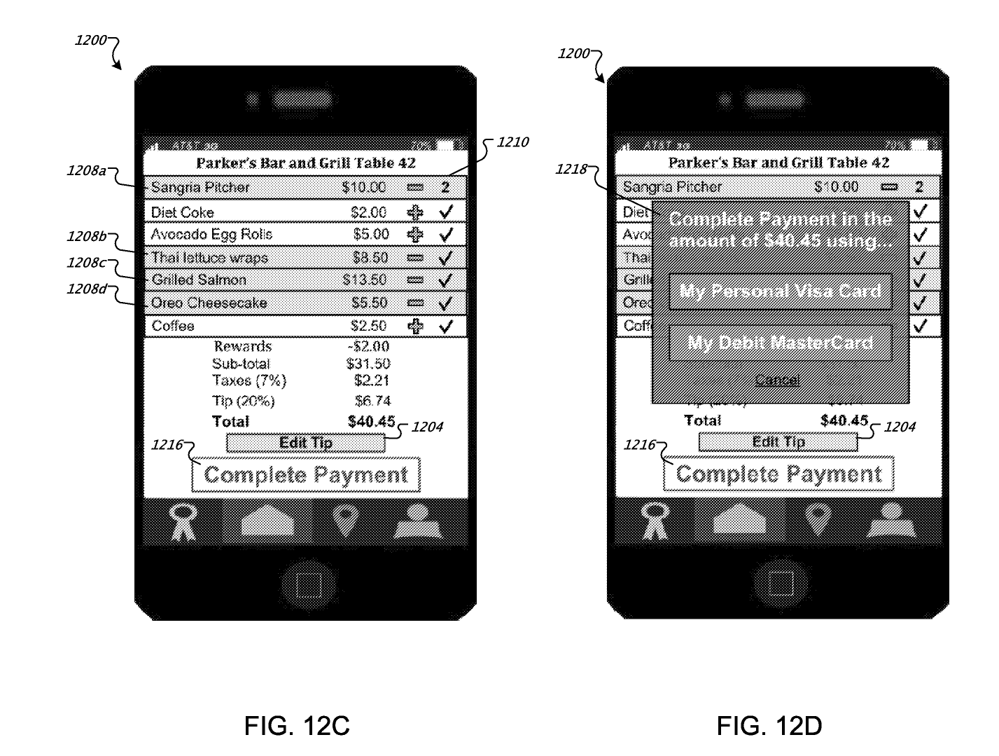

FIGS. 12A-12D are screenshots.

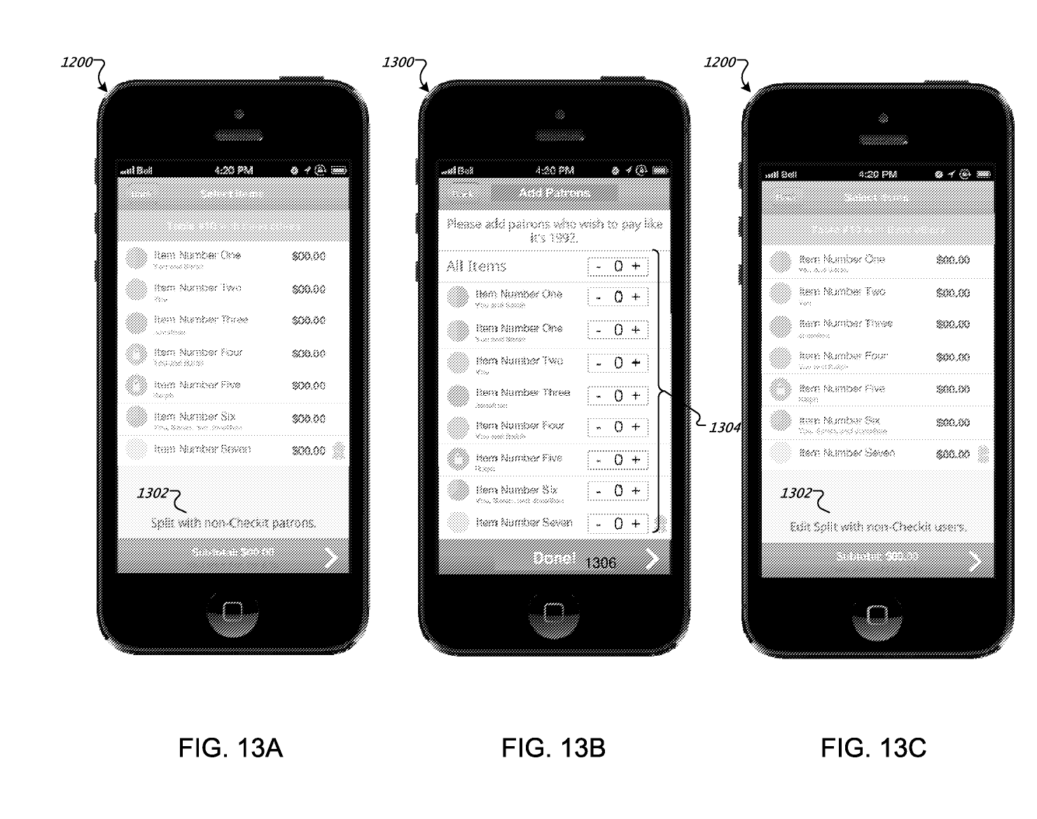

FIGS. 13A-13C are screenshots.

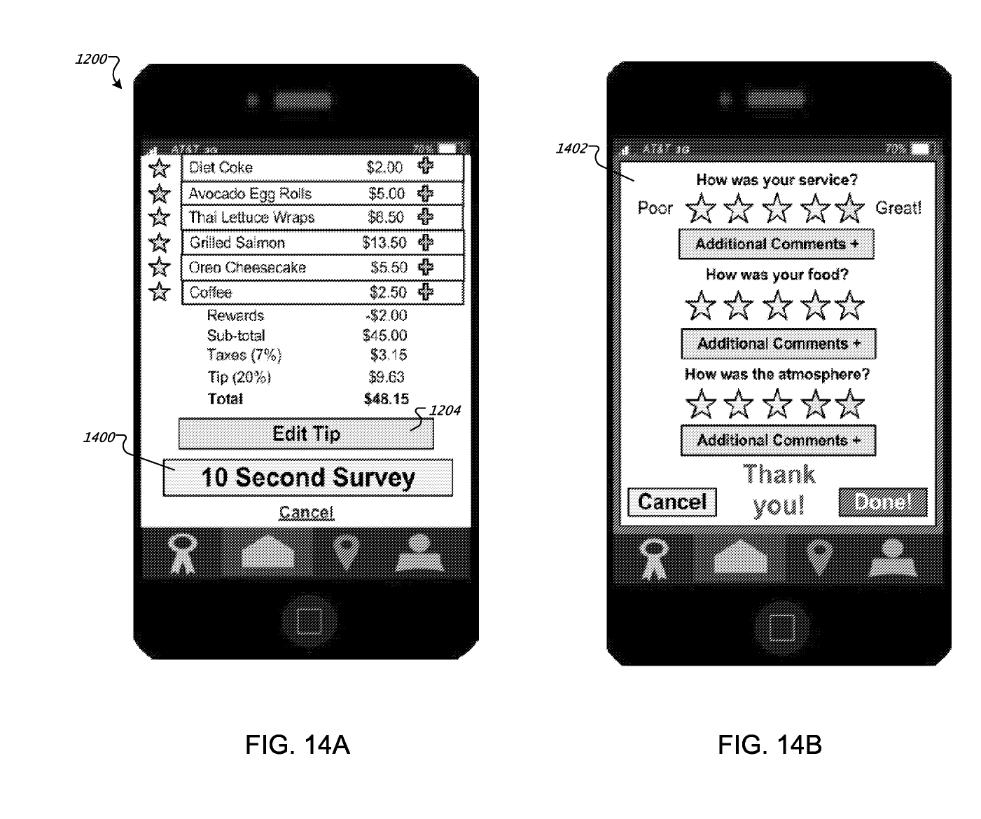

FIGS. 14A and 14B are screenshots.

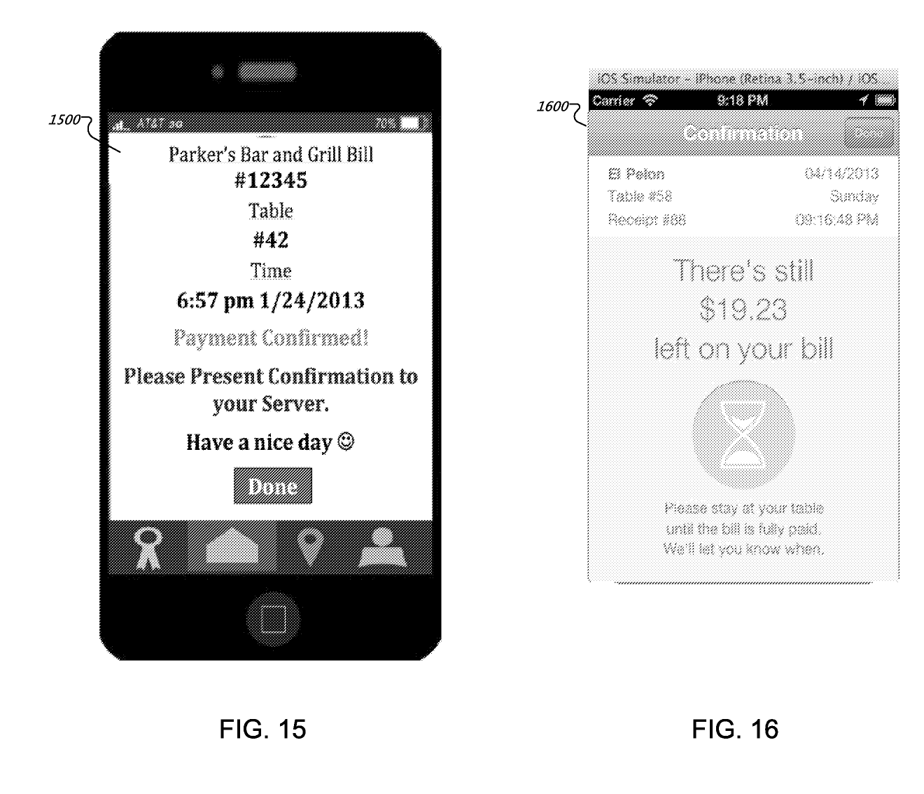

FIGS. 15-17 are screenshots.

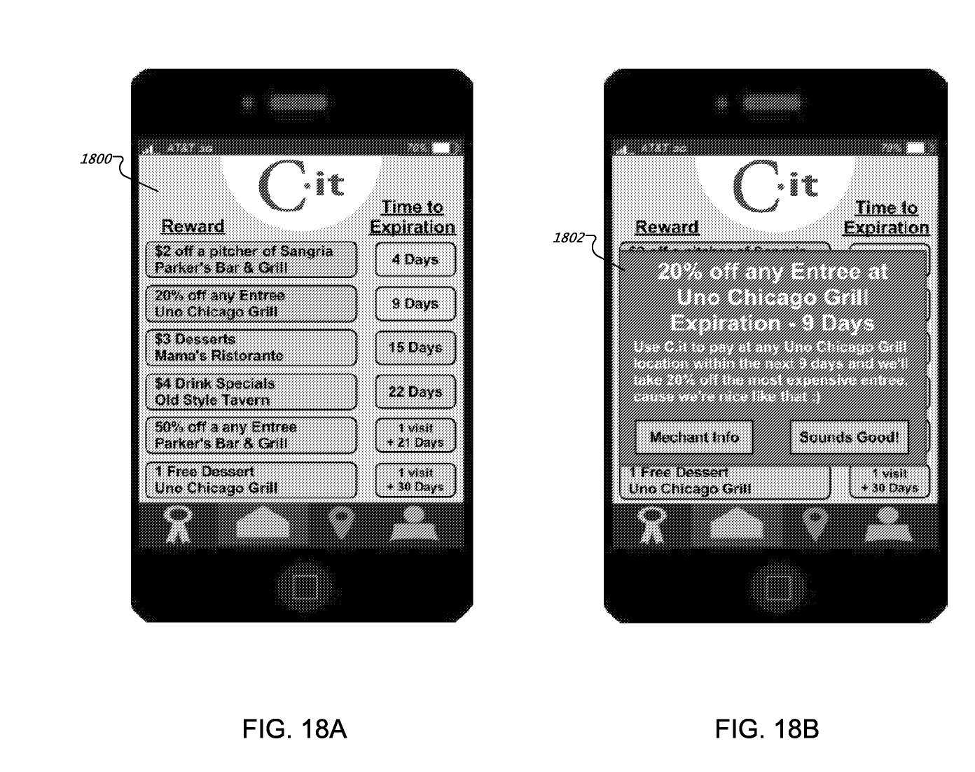

FIGS. 18A and 18B are screenshots.

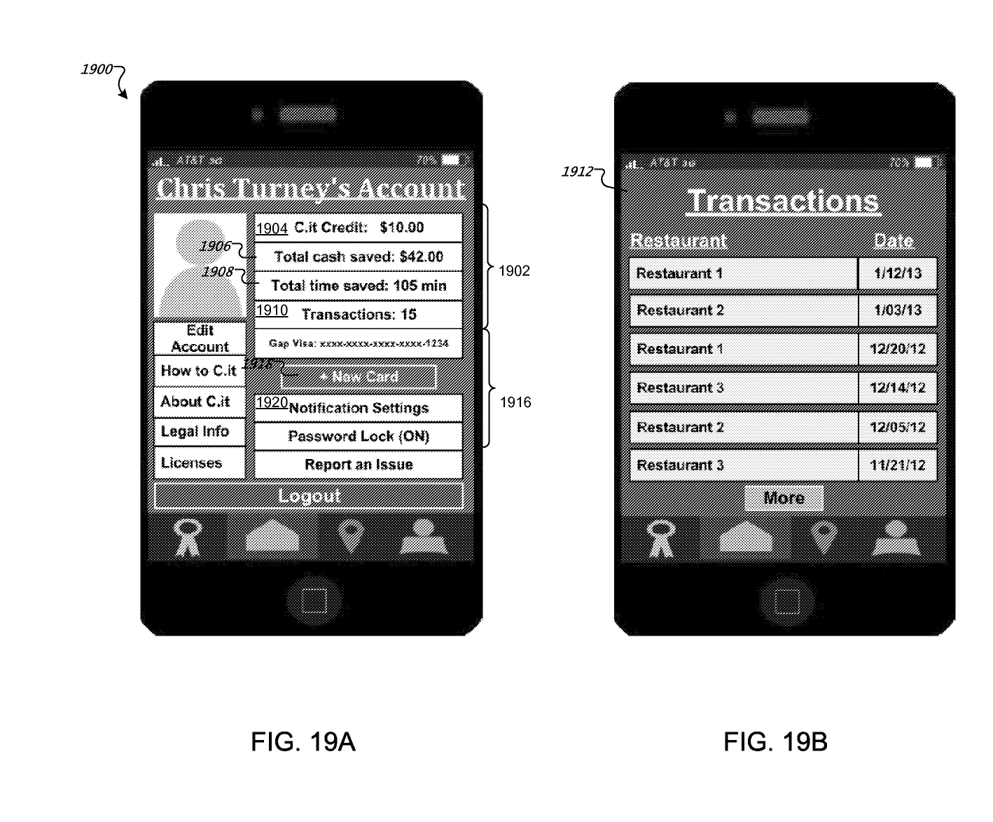

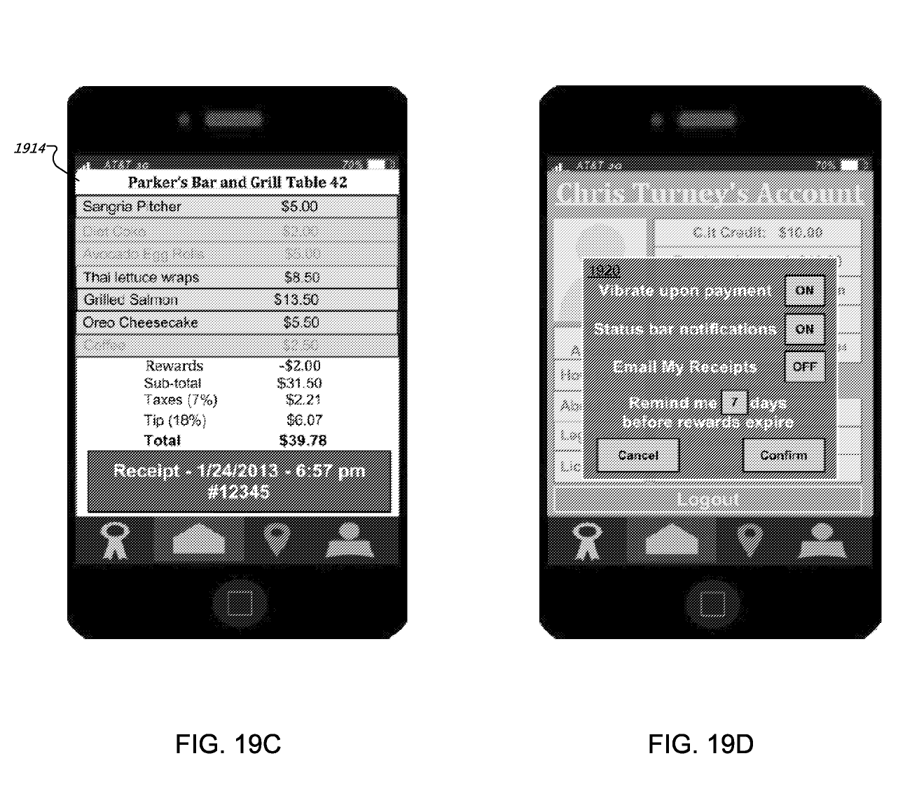

FIGS. 19A-19D are screenshots.

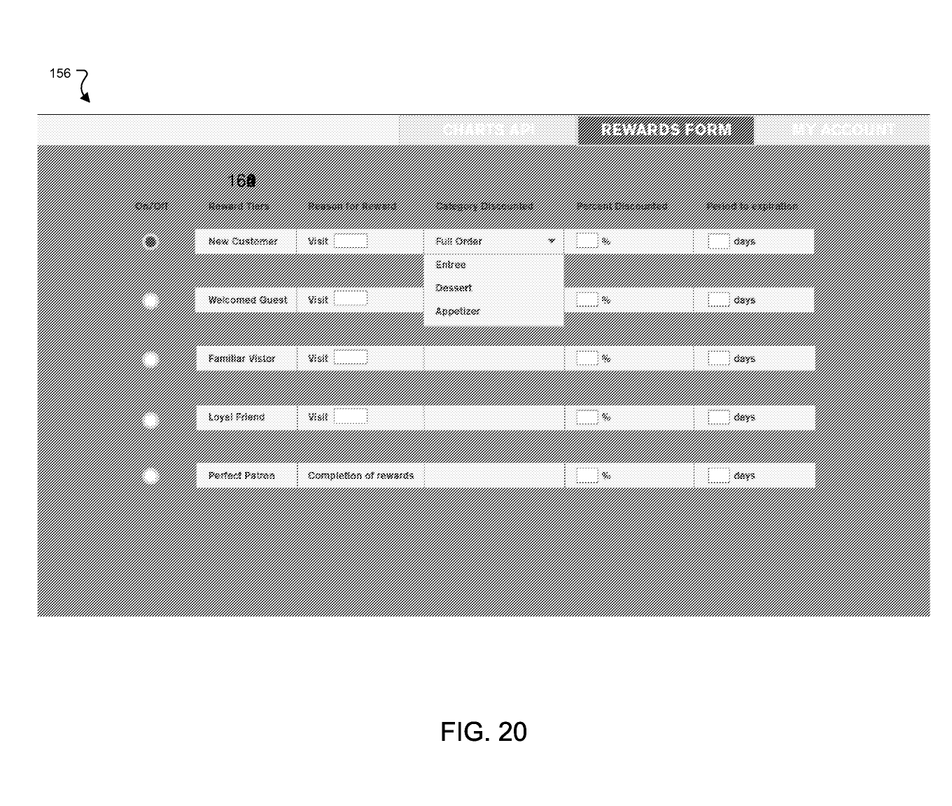

FIG. 20 is a screenshot.

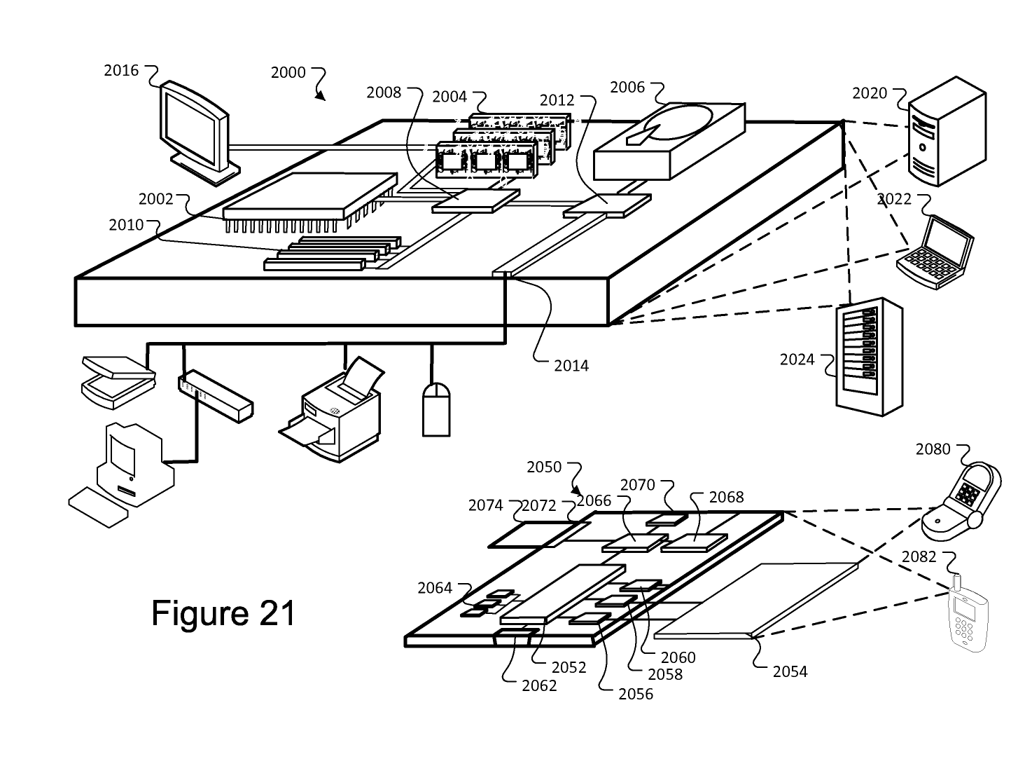

FIG. 21 is a block diagram.

The mobile payment system we describe here enables a customer at a restaurant to pay for his restaurant bill using a mobile device. The mobile payment system identifies the restaurant where the customer is dining, links the customer's ticket at the restaurant to the customer's account in the mobile payment system, and displays the customer's restaurant bill on his mobile payment device.

The customer can select to pay for one or more items on the bill. For instance, if the customer is dining in a group, the customer can select only those items that he ordered, leaving the remaining items for his dining companions.

Data about customer demographics and dining preferences can be tracked and analyzed to provide personalized recommendations or rewards to customers and to provide restaurants with insight into the behavior of their customers.

Referring to FIG. 1A, in an example of a mobile payment system 100, a user 102 dining at a restaurant 104, such as a sit-down restaurant, is able to pay his bill using a restaurant application 108 (referred to here as a “restaurant app”) on a mobile device 106, such as a smartphone, laptop, or tablet. The mobile device 106 communicates with a system server 110 of the mobile payment system 100 via a communications network, such as the Internet 112, to enable the user to pay his restaurant bill using the mobile device.

In some examples, the restaurant 104 where the user is dining can be identified based on information about the location of the mobile device 106, such as Global Positioning System (GPS) data, Wi-Fi network data, data from triangulation of cellular communications towers, input from the user 102, or a combination of any two or more of them. For instance, the restaurant app 108 may send location data 111 to the system server 110 hosting a restaurant database 114 storing restaurant data 113, such as names and locations of restaurants participating in the mobile payment system. A location module 115 at the system server 110 identifies one or more restaurants near the location of the mobile device 106 and sends restaurant data 116 identifying those restaurants to the mobile device for display. The user 102 can confirm that he is at the restaurant 104 identified on the display, select the restaurant 104 from a displayed list of restaurants, or identify the restaurant 104 by entering its name or other information. The user 102 can also enter his table number or ticket number, select his table number from a list of available table numbers at the restaurant 104, or provide other information enabling the restaurant app 108 to associate an open ticket at the restaurant 104 with the user 102. A billing module 117 at the system server 110 links a username or identifier of the user in the system 100 with an identifier of the restaurant, the user's table number, and a timestamp.

In some examples, the name of the restaurant 104, the user's table, or both, can be automatically entered into the mobile payment system, e.g., based on the user's interactions with the restaurant. For instance, if the user makes a reservation with the restaurant 104 and supplies an identifier of his account with the mobile payment system 100, the mobile payment system 100 can determine that the user will dine at the restaurant 104 on the date of the reservation. Similarly, if the user arrives at a restaurant that uses a computerized guest list and provides an identifier of his account with the mobile payment system, the mobile payment system 100 may detect which table is assigned to the user by the computerized guest list. By computerized guest list, we mean a computer based record of guest arrivals and table assignments.

At the restaurant 104, the user 102 places an order with a restaurant server 118. The restaurant server 118 enters order data 120 into a point-of-sale (POS) terminal 122. The POS terminal 122 associates the order data 120 with the user's table number, ticket number, or other identifier. When the user 102 is ready to pay his bill, he requests the bill on the mobile device 106. The mobile device 106 sends a bill request 124 to the billing module 117 at the system server 110, which in turn sends a bill request 126 including the user's table number, ticket number, or other identifier via a network (e.g., the Internet 112) to the POS terminal 122. A POS module 128 (e.g., a software plug-in provided by SubtleData™ (Austin, Tex.)) at the POS terminal 122 captures bill data 130 for the appropriate table number, ticket number, or other identifier, including the name, quantity, and price of each item ordered, any applicable tax or gratuity, any applicable discounts, or a combination of any two or more of them. The POS module 128 sends the bill data 130 to a billing database 132 hosted by the system server 110 (or by another computer). The system server 110 sends the bill data 130 to the user's mobile device 106 for display.

Referring to FIG. 1B, the user 102 selects the items on the bill that he intends to pay for. If the user 102 is dining alone, the user 102 can select all of the items. If the user 102 is dining with one or more companions, the user 102 can select fewer than all of the items, leaving the remaining items for his companions. The user 102 can also specify a tip amount. In some examples, the user 102 inputs payment information, such as a credit card number, debit card number, PayPal™ account information, or other payment information. In some examples, payment information 133 for the user is already stored, e.g., in an account database 134 hosted by the system server 110 or by a payment processing server 136, such as the server of a third party payment processing system.

The mobile device 106 sends payment data 138, including identifiers of the selected items, the tip amount, and the payment information (if appropriate), to the billing module 117 at the system server 110. In some examples, the billing module 117 transmits the payment data 138 and a user identifier 140 to the payment processing server 136, which communicates with the POS terminal 122 to enable a payment to be made for the selected items. For instance, the payment processing server 136 accesses payment information 133 associated with the user identifier 140 and sends that payment information 133 along with the payment data 138 to the POS terminal 122. In some examples, the billing module 117 can send the user's payment information 133 and the payment data 138 directly to the POS terminal 122 to enable a payment to be made for the selected items. The POS terminal 122 processes the user's payment information 133 to pay for the selected items. In some examples, the payment can be processed by the POS terminal 122 as a credit card swipe transaction. Once the payment has been processed, the POS terminal 122 sends a payment confirmation 142 to the system server 110, which transmits the payment confirmation 142 to the user's mobile device 106 for display.

Referring to FIG. 2, when a group of people 102a, 102b, 102c is dining together, the mobile payment system 100 enables each person to use a mobile device 106a, 106b, 106c to select and pay for some of the items on the bill (e.g., the items he ordered), allowing the group to split the bill easily and naturally among themselves. For instance, each person can select and pay for the entrée and drink that he ordered. In some examples, selection data 144, indicative of which items on the bill have been selected (or deselected) by which person, are transmitted in real time (e.g., continuously, at regular intervals, or every time an item is selected or deselected) from each mobile device 106a, 106b, 106c to the billing module 117. The billing module 117 can send updated bill data 130 to each mobile device 106a, 106b, 106c in real time (e.g., continuously, at regular intervals, or every time an item is selected or deselected). In some examples, once an item has been selected and paid for by a person, the item is locked from further payment by the other people. The bill displayed on the mobile devices 106a, 106b, 106c can reflect which items have been selected and which items have been paid for. In some examples, the bill indicates only that an item has been selected or paid for; in some examples, the bill can indicate which person selected each item, which person paid for each item, or both.

In some examples, the mobile payment system 100 enables multiple people to select the same item on the bill, allowing people who shared an item to split the cost of that item. The billing module 117 divides the cost of the shared item by the number of people who select the item to determine how much each person will pay for the item. For instance, if two people 102a, 102b shared an appetizer, each person can select that appetizer on the bill, and each person will pay for half of the cost of the appetizer. In some examples, once a portion of a split item has been paid for by one of the people, the portion of the item that has been paid for is locked from further splitting and payment. Any portion of the item that has not yet been paid for is available for further splitting. For instance, in the appetizer example, if person 102a pays for his half of the appetizer, that half of the appetizer is locked and cannot be further split. However, person 102b can further split his half of the appetizer with person 102c, such that people 102b, 102c each pay for 25% of the total cost of the appetizer. In some examples, the bill displayed on each mobile device 106a, 106b, 106c can indicate the number of people who have selected each item. The split of items for payment among different people in a group does not necessarily reflect the split of consumption of the menu items, but can reflect some other principle. For example, two people could treat two other people to part of their dinners.

In some examples, one or more people in the group (e.g., people 102a, 102b) can pay using their mobile devices 106a, 106b and one or more people (e.g., person 102c) can pay directly at the restaurant, e.g., using cash or a credit or debit card. In some cases, the people 102a, 102b paying with their mobile devices 106a, 106b can select and pay for their items. Their payment data 138 is sent via the payment processing server 136 to the POS terminal 122. The POS terminal adjusts the bill to account for the mobile device payments, and a paper check 146 with the adjusted bill can be presented to the person 102c paying directly at the restaurant (referred to here as the “cash payment person”).

In some cases, the POS terminal can generate a separate check 146 for each cash payment person 102c. For instance, a mobile device user (e.g., person 102a) can specify which items the cash payment person 102c intends to pay for. Cash item information 148 identifying which items will be paid for by each cash payment person is sent from the mobile device 106a to the system server 110, which transmits the cash item information 148 to the POS terminal 122. The POS terminal 122 generates checks 146 for each cash person 120c based on the cash item information 148.

Referring to FIG. 3, to use the mobile payment system to pay a restaurant bill, a user who is registered with the mobile payment system logs into the restaurant app (300). The restaurant where the user is dining and the table number where the user is seated are identified (302). For instance, the user can confirm that he is at a restaurant identified by the mobile payment system, select the restaurant he is at from a list of restaurants, or enter the name of the restaurant he is at. In some examples, the restaurant, the table number, or both can be automatically identified by the mobile payment system, e.g., based on the user's interactions with the restaurant. The mobile payment system links a username or identifier of the user in the mobile payment system with an identifier of the restaurant, the user's table number, and a timestamp.

The user places an order with a restaurant server (304), who enters the order into a POS terminal at the restaurant as an open ticket (306). When the user is ready to pay, he requests the bill from the mobile device (308). Bill data associated with the user's open ticket is provided from the POS terminal to the mobile payment system and sent to the user's mobile device for display (310).

The user selects the items on the bill that he intends to pay for (312). The user can also specify a tip amount, if desired (314). The user's payment instructions are processed by a payment processing system and provided to the POS terminal at the restaurant (316). The POS terminal processes the user's payment (318) and provides a payment confirmation to the mobile payment system for display on the user's mobile device (320). If the bill has been paid in full (322), the user's ticket is closed (324). If the bill has not been paid in full (e.g., if items remain on the bill that have not yet been paid for), the ticket remains open (326). Further payment can be received from another mobile device (308) or as a direct payment at the restaurant, e.g., with cash or a credit or debit card.

Referring to FIG. 4, to access the mobile payment system, a user who is registered with the mobile payment system logs into the restaurant app via login screens 400, 402. In some examples, the user can log into the restaurant app using login information from social networking facilities, such as Facebook™ or Google+™ (e.g., via login screen 400). In some examples, the user logs in using a dedicated username and password for the restaurant app (e.g., via login screen 402).

Referring to FIGS. 5A and 5B, if the user is not registered with the system, the user can create an account by providing the appropriate personal information and payment information via a registration screen 500. For instance, the user can provide credit card, debit card, or PayPal™ information. A credit screen 502 enables the user to enter credit card or debit card information manually or to use the mobile device to scan the user's credit or debit card. In some examples, the user's account with the mobile payment system can be linked to a social networking account used by the user, such as a Facebook™ or Google+™ account.

Referring to FIGS. 6A-6F, the user, the mobile payment system, or both identify the restaurant where the user is dining. A map 600 can be displayed on the user's mobile device that indicates the location of the mobile device, e.g., as determined from GPS signals, Wi-Fi signals, cellular triangulation, or other approaches. In some examples, a likely restaurant can be identified based on the location and a confirmation prompt 602 is displayed on the mobile device. For instance, the closest participating restaurant within a specified range (e.g., a 0.2 mile radius) of the location can be identified as the likely restaurant. In some examples, a list of possible restaurants 604, a searchable map 606 of closest restaurants, or a searchable list 608 of closest restaurants is displayed on the mobile device. If the mobile payment system is unable to identify the restaurant where the user is dining, e.g., because the restaurant does not participate in the mobile payment system or because of a processing error, an error message 610 can be displayed.

In some examples, the name of the restaurant where the user is dining is automatically entered into the mobile payment system, e.g., based on the user's interactions with the restaurant. For instance, if the user makes a reservation with a particular restaurant, the mobile payment system can determine that the user will dine at that restaurant on the date of the reservation. In some cases, the confirmation prompt 602 is presented to the user. In some cases, no confirmation prompt is presented.

Referring also to FIG. 7, in some examples, when the user responds to the confirmation prompt 602 or selects a restaurant from one of the lists 604, 608 or the map 606, a profile page 700 including information about the restaurant is displayed. The profile page 700 can include information such as the address and phone number of the restaurant, a map to the restaurant, the operating hours of the restaurant, a summary or links to reviews of the restaurant, other information about the restaurant, or a combination of any two or more of them. The profile page 700 can also include a rewards display 702 highlighting discounts or other rewards available to the user at the restaurant. In some examples, the rewards display 702 can be personalized to the user, e.g., based on the user's history at the restaurant or at other restaurants. In some examples, the rewards display 702 can be specific to the restaurant, e.g., displaying a discount available to anyone who dines at the restaurant.

Referring to FIG. 8, in some examples, the user inputs his table number, ticket number, or other type of identifier at a prompt 800. In some examples, the user's table number, ticket number, or other type of identifier can be automatically entered into the system, e.g., based on the user's interactions with the restaurant. For instance, if the user arrives at a restaurant that uses a computerized guest list and provides an identifier of his account with the mobile payment system, the mobile payment system may detect which table was assigned to the user by the computerized guest list. In these examples, the prompt 800 may not be presented to the user.

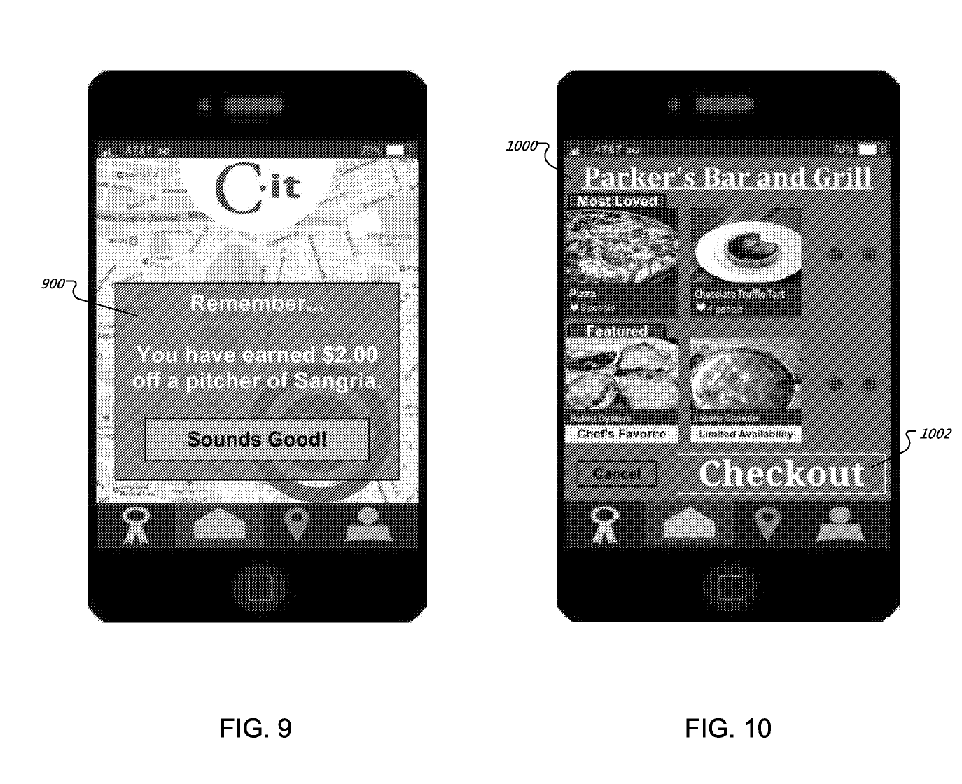

In some examples, rewards and recommendations for the restaurant can be displayed to the user. For instance, referring to FIG. 9, in some examples, a reward 900 available to the user for use at the restaurant can be displayed, e.g., after the user has checked in at the restaurant or at the table. The reward may be a discount or another reward that is personalized for the user, e.g., based on the user's history at the restaurant or at other restaurants. The reward may be a discount or another reward that is specific to the restaurant but not to the user, e.g., available to anyone who dines at the restaurant. Referring to FIG. 10, in some examples, recommended or featured items 1000 can be displayed on the mobile device. The items can be recommended for the user based on the user's order history at the current restaurant or at other restaurants. The items can also include items that are featured by the restaurant, such as daily specials, new items, or most popular items.

Referring to FIGS. 11A-11B, in some examples, the user can view a menu overview 1100 or a detailed menu 1102 for the restaurant. In some examples, the user can place an order via the mobile device.

Referring again to FIG. 10, when the user is ready to pay his bill, he selects a “Checkout” button 1002. In the depicted example, the “Checkout” button 1002 is shown along with the recommended or featured items 1000. The “Checkout” button can also be shown in other display configurations. For instance, the “Checkout” button can be shown when the user inputs his table number or can be shown in its own display.

Referring to FIGS. 12A-12D, the user's bill 1200 is displayed on the mobile device. The bill 1200 lists the items included on the ticket for the user's table and the price for each item. The user can toggle an indicator 1202 to select or deselect items for payment. The bill 1200 also displays any rewards applicable to the selected items, the taxes and tip for the selected items, and the total charge for the selected items. The user can select an “Edit Tip” button 1204 (FIG. 12B) to adjust the tip amount using a tip calculator 1206. The user can also highlight a marker 1207 to mark an item as a favorite item, e.g., to be reminded of that item during a future visit to the restaurant.

In FIG. 12A, none of the items on the bill 1200 has been selected for payment, and the tax, tip, and total refer to the entire bill. In FIG. 12C, the Sangria pitcher 1208a, the Thai lettuce wraps 1208b, the Grilled Salmon 1208c, and the Oreo Cheesecake 1208d have been selected by the user, as indicated by the highlighting and the “−” indicator 1202 next to the selected items 1208a-1208d. A status column 1210 indicates with a checkmark the items that have been selected by at least one person. A number in the status column 1210 indicates that an item has been selected by that number of people. In calculating the bill, the cost of the item that has been selected by multiple people will be split among those people. For instance, the Sangria pitcher 1208a was selected by two people, so each person will pay $5.00 towards the cost of the Sangria pitcher.

When the user has completed his selection of items, he selects a “Complete Payment” button 1216 (FIG. 12D). A payment prompt 1218 is displayed to allow the user to select his desired method of payment. For instance, the payment prompt 1218 can display buttons for any credit or debit cards, PayPal™ accounts, or other payment methods that the user has linked to his account.

Referring to FIGS. 13A-13C, to split the bill between one or more people paying with mobile devices and one or more people paying directly at the restaurant, a splitting interface 1300 can be displayed. The splitting interface 1300 enables a user of a mobile device to specify which items are to be paid for by which person. For instance, to accommodate people paying directly at the restaurant, the user can select a “Split” button 1302 from the bill 1200. The user can then indicate, via buttons 1304 on the splitting interface 1300, how many people who are not paying with a mobile device are splitting each of the items. The number of people splitting each item enables the system to calculate what each mobile device user owes, without having to wait for the people not using mobile devices to receive the check and calculate their portion of the bill. Once the addition of other people has been completed, the user selects “Done” 1306 to return to the bill 1200. The user can return to the splitting interface 1300 if desired to adjust the number of people who are paying for each item.

Referring to FIGS. 14A and 14B, in some examples, the user can select a “Survey” button 1400 to respond to survey questions 1402 supplied by the restaurant or by the mobile payment system prior to payment. The user's responses to the survey questions 1402 can be used to analyze the user's preferences or can be used in combination with responses from other users to analyze trends.

Referring to FIG. 15, when the user's payment has processed, a confirmation message is displayed. For instance, a confirmation message 1500 is displayed that includes information such as the ticket number, the table number, and the time of payment.

Referring to FIG. 16, in some examples, such as when multiple people are each paying a portion of the same bill, an intermediate confirmation message 1600 can be displayed when the user's own payment has processed. The intermediate confirmation message 1600 indicates a status of the bill, e.g., by indicating that the ticket for the user's table is still open or by showing the amount still left on the bill. The intermediate confirmation message 1600 can be updated in real time as other people pay their portions of the bill. A final confirmation message, such as the confirmation message 1500, can be displayed when the bill is completely paid and the user's ticket has been closed.

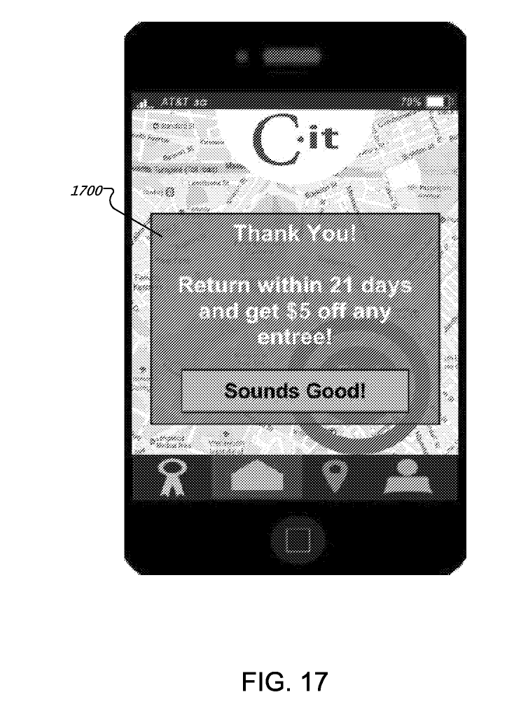

Referring to FIG. 17, in some examples, a rewards notification 1700 can be displayed, e.g., after payment of the bill. For instance, the rewards notification 1700 can offer the user a discount if he returns to the same restaurant within a certain period of time. The reward may be personalized for the user, e.g., based on the user's history at the restaurant or at other restaurants. The reward may be specific to the restaurant but not to the user, e.g., available to anyone who dines at the restaurant.

Referring to FIGS. 18A and 18B, the user can view a list 1800 of rewards available to him along with the expiration date of each reward. The user can select a particular reward to view a display 1802 with more detailed information about the reward. From the display 1802, the user can select a “Merchant Info” button to view a profile page for the restaurant offering the reward (e.g., the profile page 700 shown in FIG. 7).

Referring to FIG. 19A, the user can view an account management interface 1900 that enables the user to view information 1902 about his transaction history. For instance, the user can view his credit 1904 with the mobile payment system, which he may have purchased, received as a gift, received from a promotion, earned from restaurant rewards, special offers from the mobile payment system, or in another manner. In one example, a promotion may offer a $20 credit to any user who purchases a certain brand of beer during a specified time frame. The user can view his cash savings 1906, time savings 1908, and number of transactions 1910 over a set period of time, such as over the past month or the past year. In some examples, the user can customize the time period. Referring also to FIG. 19B, by selecting the transactions 1910, the user can view a list 1912 of all recent transactions. Referring to FIG. 19C, the user can select one of the transactions to view a receipt 1914 for that transaction.

The user can also view information 1916 about his account with the mobile payment system. For instance, the user can add a new payment account 1918, such as a new credit card, debit card, or PayPal™ account. The user can view or set his notification settings 1920. Referring also to FIG. 19D, the notification settings 1920 can include types of payment notifications, such as vibrations, status bar updates, and emails. The notification settings 1920 can also include reminders of rewards that are about to expire.

In some examples, user data can be tracked and automatically analyzed to discover patterns or trends in the data, such as commercially relevant patterns or trends. For instance, the patterns or trends may illuminate dining habits of certain types of users, preferred types of cuisine for certain types of users, the most popular items at a particular restaurant during a particular time period, or other patterns or trends. The results of the analysis can be used, e.g., to provide feedback to restaurants about its customers and to provide personalized recommendations or advertisements to users. Referring again to FIG. 1, an analytics module 150 hosted on the system server 110 analyzes transaction data 152 stored in an analytics database 154. The analysis can be conducted on a per-user basis to discover patterns and trends for a particular user. The analysis can also be conducted on a larger scale to discover patterns and trends for a group of users, such as for users of a particular demographic group, or for all users of the mobile payment system.

The transactions enabled by the mobile payment system 100 involve items ordered from a sit-down restaurant. These items can include, e.g., food, beverages, and memorabilia. The items ordered and the transaction itself can be tagged with metadata including, e.g., time of day, time of bill creation, time of bill close, day of week, number of users linked to the transaction, demographic information of the users linked to the transaction (e.g., zip code, sex, age, employment, frequency of dining at the restaurant, loyalty of dining at the restaurant, and other demographic information), age of offering (i.e., how long an item has been available for at the restaurant), the waiter serving the table or serving a particular item, the number of items in the transaction, the main ingredients of each item in the transaction, the cuisine type of each item in the transaction (e.g., French or Italian), the dish type of each item (e.g., an appetizer or a dessert), other metadata, or a combination of any two or more of these metadata. This metadata can be stored as transaction data 152 in the analytics database 154.

In one example, the analytics database 154 stores the following data:
User information
   Email address
   First name
   Last name
   Gender
   Date of birth
   Join date
   Number of transactions
   Zip code
   Education level
   Employment status
   Income level
   Likes or interests (e.g., pages “liked” on Facebook™)
   “Living” info (location, such as hometown or current town)
   Relationship status
   Phone number
User-specific transaction information
   Subtotal for the user
   Tip amount
   Tax amount
   Process time
   Payment method used (e.g., an identifier of the credit card used)
   Ticket number
   Items selected by the user
Ticket information
   Created time
   Closed time
   Merchant location identifier
   Table identifier
Item information
   Item name
   Item quantity
   Item identifier (e.g., POS identifier)
   Item price
User rewards
   Created date
   Expiration date
   Used date
   Merchant identifier
   Value

The analysis of the transaction data 152 by the analytics module 150 can illuminate trends and patterns in the data. As an example, the analytics module 150 may discover that, at Restaurant A, five other items are ordered on average when nachos are part of an order. In another example, the analytics module 150 may discover that, at Restaurant A, tables that order nachos order an average of 2.1 items per person. In another example, the analytics module 150 may discover which items are Restaurant B's most popular items from 5-7 pm on weeknights, which items are most popular with young professional women, or which featured items are the most popular with families.

The results of the data analysis can be provided to restaurants, which can leverage the data to gain insights into operations, products, customers, marketing approaches, and other aspects of their business. For instance, the results can be used by restaurants to help identify appropriate rewards to be provided to specific subsets of customers, identify survey questions to be offered to specific subsets of customers, monitor menu performance, update menu offerings, make marketing decisions, or predict future orders.

In some examples, the results of the data analysis can be provided to restaurants via a dashboard interface 156 accessible by a computing device 158, such as a laptop or desktop computer or a mobile device. The restaurants can view the results, search the data, or set up their own analysis rules. Restaurants can use the dashboard interface to set up automated actions that are triggered by an action of a user. The automated actions can include rewards, surveys, or brand promotions that are displayed to a user, emails (e.g., marketing emails) that are sent to a user, notifications to staff (e.g., a notification of a repeat customer), or other automated actions. For instance, a restaurant can cause a 10% discount reward to be displayed to any user who spends more than $50. Referring to FIG. 20, an example dashboard interface 156 allows a restaurant to specify rewards criteria and rewards information for various tiers 160 of users. For instance, a restaurant can specify criteria such as a number of visits 162 after which a user of a particular tier qualifies for the specified reward. A restaurant can also specify rewards information such as a category of the discount 164 (e.g., a discount on the user's full order or a discount on a particular type of menu item), a percent of the discount 166, and an expiration period 168.

The results of the data analysis can also be used by the analysis module 150 to provide personalized recommendations to users, e.g., about restaurants or dishes that the user might enjoy based on his past dining history or based on the dining history of other similar users. The results can also be used to sell targeted advertising space to advertisers who wish to target certain types of consumers.

FIG. 21 shows an example of a personal computing device 2000 and a mobile device 2050, which may be used with the techniques described here. Computing device 2000 is intended to represent various forms of digital computers, such as laptops, desktops, workstations, personal digital assistants, servers, blade servers, mainframes, and other appropriate computers. Computing device 2050 is intended to represent various forms of mobile devices, such as personal digital assistants, cellular telephones, smartphones, tablets, and other similar computing devices. The components shown here, their connections and relationships, and their functions, are meant to be examples only, and are not meant to limit implementations of the techniques described and/or claimed in this document.

Computing device 2000 includes a processor 2002, memory 2004, a storage device 2006, a high-speed interface 2008 connecting to memory 2004 and high-speed expansion ports 2010, and a low speed interface 2012 connecting to low speed bus 2014 and storage device 2006. Each of the components 2002, 2004, 2006, 2008, 2010, and 2012, are interconnected using various busses, and may be mounted on a common motherboard or in other manners as appropriate. The processor 2002 can process instructions for execution within the computing device 2000, including instructions stored in the memory 2004 or on the storage device 2006 to display graphical information for a GUI on an external input/output device, such as display 2016 coupled to high speed interface 2008. In other implementations, multiple processors and/or multiple buses may be used, as appropriate, along with multiple memories and types of memory. Also, multiple computing devices 2000 may be connected, with each device providing portions of the necessary operations (e.g., as a server bank, a group of blade servers, or a multi-processor system).

The memory 2004 stores information within the computing device 2000. In one implementation, the memory 2004 is a volatile memory unit or units. In another implementation, the memory 2004 is a non-volatile memory unit or units. The memory 2004 may also be another form of computer-readable medium, such as a magnetic or optical disk.

The storage device 2006 is capable of providing mass storage for the computing device 2000. In one implementation, the storage device 2006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 2004, the storage device 2006, memory on processor 2002, or a propagated signal.

The high speed controller 2008 manages bandwidth-intensive operations for the computing device 2000, while the low speed controller 2012 manages lower bandwidth-intensive operations. Such allocation of functions is an example only. In one implementation, the high-speed controller 2008 is coupled to memory 2004, display 2016 (e.g., through a graphics processor or accelerator), and to high-speed expansion ports 2010, which may accept various expansion cards (not shown). In the implementation, low-speed controller 2012 is coupled to storage device 2006 and low-speed expansion port 2014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 2000 may be implemented in a number of different forms, as shown in the figure. For example, it may be implemented as a standard server 2020, or multiple times in a group of such servers. It may also be implemented as part of a rack server system 2024. In addition, it may be implemented in a personal computer such as a laptop computer 2022. Alternatively, components from computing device 2000 may be combined with other components in a mobile device (not shown), such as device 2050. Each of such devices may contain one or more of computing device 2000, 2050, and an entire system may be made up of multiple computing devices 2000, 2050 communicating with each other.

Computing device 2050 includes a processor 2052, memory 2064, an input/output device such as a display 2054, a communication interface 2066, and a transceiver 2068, among other components. The device 2050 may also be provided with a storage device, such as a microdrive or other device, to provide additional storage. Each of the components 2050, 2052, 2064, 2054, 2066, and 2068, are interconnected using various buses, and several of the components may be mounted on a common motherboard or in other manners as appropriate.

The processor 2052 can execute instructions within the computing device 2050, including instructions stored in the memory 2064. The processor may be implemented as a chipset of chips that include separate and multiple analog and digital processors. The processor may provide, for example, for coordination of the other components of the device 2050, such as control of user interfaces, applications run by device 2050, and wireless communication by device 2050.

Processor 2052 may communicate with a user through control interface 2058 and display interface 2056 coupled to a display 2054. The display 2054 may be, for example, a TFT LCD (Thin-Film-Transistor Liquid Crystal Display) or an OLED (Organic Light Emitting Diode) display, or other appropriate display technology. The display interface 2056 may comprise appropriate circuitry for driving the display 2054 to present graphical and other information to a user. The control interface 2058 may receive commands from a user and convert them for submission to the processor 2052. In addition, an external interface 2062 may be provide in communication with processor 2052, so as to enable near area communication of device 2050 with other devices. External interface 2062 may provide, for example, for wired communication in some implementations, or for wireless communication in other implementations, and multiple interfaces may also be used.

The memory 2064 stores information within the computing device 2050. The memory 2064 can be implemented as one or more of a computer-readable medium or media, a volatile memory unit or units, or a non-volatile memory unit or units. Expansion memory 2074 may also be provided and connected to device 2050 through expansion interface 2072, which may include, for example, a SIMM (Single In Line Memory Module) card interface. Such expansion memory 2074 may provide extra storage space for device 2050, or may also store applications or other information for device 2050. Specifically, expansion memory 2074 may include instructions to carry out or supplement the processes described above, and may include secure information also. Thus, for example, expansion memory 2074 may be provide as a security module for device 2050, and may be programmed with instructions that permit secure use of device 2050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 2064, expansion memory 2074, memory on processor 2052, or a propagated signal that may be received, for example, over transceiver 2068 or external interface 2062.

Device 2050 may communicate wirelessly through communication interface 2066, which may include digital signal processing circuitry where necessary. Communication interface 2066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 2068. In addition, short-range communication may occur, such as using a Bluetooth, WiFi, or other such transceiver (not shown). In addition, GPS (Global Positioning System) receiver module 2070 may provide additional navigation- and location-related wireless data to device 2050, which may be used as appropriate by applications running on device 2050.

Device 2050 may also communicate audibly using audio codec 2060, which may receive spoken information from a user and convert it to usable digital information. Audio codec 2060 may likewise generate audible sound for a user, such as through a speaker, e.g., in a handset of device 2050. Such sound may include sound from voice telephone calls, may include recorded sound (e.g., voice messages, music files, and so forth) and may also include sound generated by applications operating on device 2050.

The computing device 2050 may be implemented in a number of different forms, as shown in the figure. For example, it may be implemented as a cellular telephone 2080. It may also be implemented as part of a smartphone 2082, personal digital assistant, tablet computer, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Other implementations are also within the scope of the following claims.

What is claimed is:

1. A method comprising:
identifying a restaurant where a user of a mobile device is located;
receiving, from the restaurant, data indicative of one or more items on a bill associated with the user;
providing the data to the mobile device; and
enabling the user to pay for one or more of the items on the bill using the mobile device.

2. The method of claim 1, in which identifying the restaurant includes determining a location of the mobile device.

3. The method of claim 2, in which determining the location of the mobile device includes determining the location based on location data received by the mobile device.

4. The method of claim 1, in which identifying the restaurant includes identifying the restaurant based on data from the mobile device representative of input from the user.

5. The method of claim 1, comprising sending a request for the data to the restaurant.

6. The method of claim 1, comprising identifying a ticket associated with the user.

7. The method of claim 6, identifying a ticket associated with the user includes receiving data from the mobile device identifying a table of the user.

8. The method of claim 6, comprising sending a request for the data to the restaurant, the request including an identifier of the ticket.

9. The method of claim 1, in which receiving the data includes receiving one or more of a name, a price, and a quantity associated with each of one or more of the items on the bill.

10. The method of claim 1, in which the items on the bill include items ordered by a person other than the user.

11. The method of claim 10, comprising:
providing the data to a second mobile device associated with the person other than the user; and
enabling the person other than the user to pay for one or more of the items using the second mobile device.

12. The method of claim 10, comprising enabling the person other than the user to pay for one or more items using the mobile device.

13. The method of claim 10, comprising enabling the user and the person other than the user to each pay for a respective fraction of the cost of the same item.

14. The method of claim 10, in which the data received from the restaurant includes payment data indicative of a payment by the person other than the user.

15. The method of claim 14, in which the payment data is indicative of a payment made by the person other than the user without using a mobile device.

16. The method of claim 10, in which the mobile device comprises a first mobile device, and comprising, receiving from a second mobile device, data indicative of a selection of items, a payment, or both, by the person other than the user.

17. The method of claim 1, in which enabling the user to pay for one or more of the items comprises:
receiving data from the mobile device identifying the one or more items; and
enabling the user to pay for the identified items.

18. The method of claim 1, in which enabling the user to pay for one or more of the items comprises sending data about the one or more items to a payment processor.

19. The method of claim 1, comprising providing a confirmation of payment to the mobile device.

20. The method of claim 19, in which the confirmation includes a status of the bill.

21. The method of claim 19, in which the confirmation includes an amount still owed on the bill.

22. The method of claim 1, comprising identifying a reward available to the user.

23. The method of claim 22, in which the reward is a discount.

24. The method of claim 22, in which identifying the reward includes identifying the reward based on the restaurant, the items on the bill, or both.

25. The method of claim 22, in which identifying the promotion includes identifying the most relevant reward based on a history of actions of the user.

26. The method of claim 25, in which the history of actions of the user includes a history of actions of the user related to dining.

27. The method of claim 26, in which the history of actions of the user related to dining includes a history of restaurants visited by the user, a history of items on bills associated with the user, or both.

28. A computer readable medium storing instructions for causing a computer system to:
identify a restaurant where a user of a mobile device is located;
receive, from the restaurant, data indicative of items on a bill associated with the user;
provide the data to the mobile device; and
enable the user to pay for one or more of the items on the bill using the mobile device.

29. A method comprising:
receiving input from a user at a mobile device identifying a restaurant where the user is located;
receiving data at the mobile device indicative of items on a bill from the restaurant, the bill associated with the user;
displaying a representation of the items on the bill on a user interface of the mobile device; and
receiving input from the user selecting one or more of the items for payment.

30. The method of claim 29, in which receiving input from the user identifying the restaurant includes receiving a selection of the restaurant from a plurality of restaurants.

31. The method of claim 29, comprising receiving input from the user indicative of a ticket associated with the user.

32. The method of claim 31, in which receiving input indicative of a ticket includes receiving an identification of a table of the user.

33. The method of claim 29, comprising enabling selection of one or more of the items.

34. The method of claim 33, in which enabling the selection comprises enabling the user to select a first item and enabling a person other than the user to select a second item.

35. The method of claim 34, in which the first item and the second item comprise the same item.

36. The method of claim 35, in which the user and the person other than the user each pay for a respective fraction of the cost of the same item.

37. The method of claim 29, comprising providing data identifying the selected one or more items to a computing server.

38. The method of claim 37, comprising receiving a confirmation of payment.

39. The method of claim 38, comprising displaying a representation of the confirmation on the user interface of the mobile device.

40. The method of claim 29, comprising enabling the user to specify a tip amount.

41. The method of claim 29, comprising displaying discounts available to the user on the user interface of the mobile device.

42. A computer readable storage medium storing instructions for causing a computing system to:
receive input from a user at a mobile device identifying a restaurant where the user is located;
receive data at the mobile device indicative of items on a bill from the restaurant, the bill associated with the user;
display a representation of the items on the bill on a user interface of the mobile device; and
receive input from the user selecting one or more of the items for payment.

43. A method comprising:
identifying a restaurant where a user of a mobile device is located;
receiving, from the restaurant, data indicative of items on a bill associated with the user;
providing the data to the mobile device;
enabling the user to pay for a first item on the bill using the mobile device; and
enabling a person other than the user to pay for a second item on the bill.

44. The method of claim 43, in which enabling the user to pay for the first item comprises receiving data from the mobile device associating the first item with the user.

45. The method of claim 43, in which enabling the person other than the user to pay for the second item comprises receiving data from the mobile device associating the second item with the person.

46. The method of claim 43, in which the first item and the second item are the same item.

47. The method of claim 46, in which enabling the user to pay for the first item comprises enabling the user to pay for a first fraction of a cost of the same item, and in which enabling the person other than the user to pay for the second item comprises enabling the person other than the user to pay for a second fraction of the same item.

48. The method of claim 43, in which the mobile device is a first mobile device, and comprising providing the data to a second mobile device associated with the person other than the user.

49. The method of claim 48, in which enabling the person other than the user to pay for the second item includes enabling the person other than the user to pay for the second item using the second mobile device.

50. A method comprising:
maintaining stored data about one or more users of a hosted system that enables customers of restaurants to interact on mobile devices with information that is received at the hosted system from point of sale systems operated by the restaurants and is sent to the mobile devices from the hosted system, the stored data including information about use of the system by the one or more users, and data about restaurants visited by the one or more users, data about items ordered by the one or more users, or both;
analyzing the stored data to identify commercially relevant patterns or trends; and
providing a result based on the analysis to one or more of the users, one or more of the restaurants, or both.

51. The method of claim 50, in which providing a result based on the analysis includes providing a reward to one or more of the users.

52. The method of claim 50, in which providing a result based on the analysis to one or more of the restaurants includes providing a summary of the at least some of the identified patterns or trends to one or more of the restaurants.

53. The method of claim 50, in which the patterns or trends are indicative of a behavior of a subset of the one or more users.

54. The method of claim 53, in which the patterns or trends are indicative of a behavior of a particular demographic group.

55. The method of claim 54, in which the patterns or trends are indicative of a behavior of a particular user of the one or more users.

56. The method of claim 50, in which the data includes demographic data about the one or more users.

57. A method comprising:
providing from a central server to mobile devices of diners located in restaurants that are controlled independently of one another and independently of the central server, real time information about tickets associated with the diners by point of sale systems in the respective restaurants.

58. A method comprising:
from a central server, enabling each of two or more diners at a table in a restaurant to use his respective mobile device to indicate one or more specific menu items or portions of one or more specific menu items that (a) are known to be on a ticket for the table maintained by a point of sale system of the restaurant, and (b) are to be paid for by that diner.
